(19) United States
(12) Patent Application Publication
(10) Pub. No.: US 2006/0058976 A1
(43) Pub. Date: Mar. 16, 2006

(54) Method of testing components designed to perform real-time, high resource functions

(76) Inventor: Gavin Robert Ferris, London (GB)

Correspondence Address: SYNNESTVEDT LECHNER & WOODBRIDGE LLP, P O BOX 592, PRINCETON, NJ, 08542-0592, US

(21) Appl. No.: 10/515,661

(22) PCT Filed: May 27, 2003
(86) PCT No.: PCT/GB03/02292

§ 371 Date: May 6, 2005

(30) Foreign Application Priority Data
May 27, 2002 (GB) 0212176.2
May 31, 2002 (GB) 0212524.3

(51) Int. Cl. G06F 19/00

(52) U.S. Cl. 702/123; 703/21

(57) ABSTRACT

A method of testing an engine designed to perform a real-time DSP or communications high resource function on an embedded target platform, the method comprising the steps of: (a) developing a reference engine for the high resource function, the reference engine performing the same functionality as the engine but running on a desktop computer and not the target platform; (b) conformance testing the engine against the reference engine by measuring the functionality of the engine when stimulated by stimulus vectors and comparing that functionality against the reference engine.

### BACKGROUND OF THE INVENTION

1. Field of the Invention

This invention relates to a method of testing components designed to perform real-time, high resource functions.

2. Description of the Prior Art

Modern communications system developers are encountering a number of challenges:
The new radio standards, such as UMTS, are more complex than any previous standards.
Handset developers now have to cope with multiple standards, such as GSM and UMTS, on the same DSP. Consequently there is an increasing need for multi-system integration, where communications stacks from more than one standard have to live side by side on the same platform.
In a typical design flow the tools do not work together well, which means that engineers are forced to make hardware choices early on in the product development cycle.
The existing design flows are flawed, since tools in the design flow do not work together well and are hard to use.
Hardware and software systems are becoming increasingly complex, requiring the use of large development teams, often in different geographical locations.
Modern communications standards and the applications they are used for are operating in a packet-based rather than stream-based mode. This bursty processing challenges the traditional scheduling approaches of embedded engineering.
Within infrastructure equipment there is a need for scalability of the developed solutions.
As hardware platforms and new communication standards and applications continue to evolve at a rapid pace, so the need for flexibility, portability and re-usability of the solutions produced becomes more imperative.
The pressures for rapid delivery of end-product to market and for minimising the fixed costs within that product remain as constant and as strong as ever.
As the system developments become larger the value of an early validation (or rebuttal) of the system design is of increasing value to the developments.
Engineers must continue to confront the constraints present within hard real-time systems, while at the same time minimising overall system cost by reducing the number of components.

The present invention is an element in a larger solution to the above problems, called the Communications Virtual Machine (“CVM™”) from Radioscape Limited of London, United Kingdom. Reference may be made to PCT/GB01/00273 and to PCT/GB01/00278.

The CVM addresses the following problems associated with the current design methodologies.
System Design
Portability
Performance

### SUMMARY OF THE INVENTION

The present invention, in a first aspect, is a method of testing an engine designed to perform a real-time DSP or communications high resource function on an embedded target platform, the method comprising the steps of:
(a) developing a reference engine for the high resource function, the reference engine performing the same functionality as the engine but running on a desktop computer and not the target platform;
(b) conformance testing the engine against the reference engine by measuring the functionality of the engine when stimulated by test vectors and comparing that functionality against the reference engine.

By allowing for engines to be conformance tested against an accurate behavioural description of the high resource function (i.e. the reference engine), it is possible to validate and guarantee the behavioural equivalence of that engine to any other engine that passes the same conformance test: this gives the system designer the ability to choose from one of several different target platform/engine pairs when actually deploying a system, because he knows that whichever platform he chooses, he will have an engine that runs on that platform to perform the high resource function in a way that is behaviourally the same as any other engine (specific to a different platform) he might have chosen. An engine should be expansively construed to cover any kind of component that implements a high resource function.

In an implementation, a desktop computer allows the conformance tests to be executed in the development environment of the target platform. A desktop computer should be expansively construed as any computer suitable for testing a component. The desktop computer may issue a conformance certificate that is securely associated with the engine if conformance tests for all vectors are passed. It is envisaged that this approach will allow a market for standardised, commoditised engines from numerous third party suppliers to arise (e.g. versions of the same engine, ported to run on different target platforms): the system designer can then select the most appropriate one, safe in the knowledge that it is behaviourally equivalent to a known reference.

The reference engine may be polymorphic in that it may handle a general data type covering a range of bit-widths and/or overflow behaviours: any engine whose specific data type is a sub-set of the general data type can therefore be conformance tested against that reference engine.

The engine may also be performance profiled by measuring the functionality of the engine in order to build up a set of points on a multi-dimensional surface that can later be interpolated to make useful estimates of engine execution time and resource usage. The profile indicates how well the engine should perform in terms of processor cycles and memory loading given a range of input values, such as a set of input data lengths.

A reference engine is hence essentially an engine, usually based on polymorphic data type definitions, that runs on a PC and provides the standard behaviour against which the system designer can compare candidate engines. A comparison between a reference engine and a candidate engine (an engine to be evaluated) is possible because a reference engine provides two ways of assessing engine efficacy. These are:
Conformance testing
Performance profiling

With conformance testing, the system designer runs a series of tests that judge the correctness of the functionality of the candidate engine. Each test either passes or fails, and for an engine to gain conformance it must pass all the tests.

Performance profiling is a less stringent method of evaluation, in which the system designer builds up a profile of the performance that he thinks is acceptable in an engine. The profile that is create for a reference engine indicates how well the engine should perform in terms of processor cycles and memory loading given a range of input values, such as a set of input data lengths.

Both the performance profile and the conformance tests are contained within scripts that the system designer generates when he creates a reference engine. As the reference engine created can be polymorphic, it is possible to run the tests on any candidate engine whose types fall under the wider category defined by the polymorphic types of the reference engine. So, there is no need for the system designer to write a different set of scripts for each platform he is writing a high resource function for.

Either the reference engine or the engine may be used to create a functional block and a modelling environment is used to model the performance of the functional block.

In another aspect, there is a device capable of performing a real-time DSP or communications function, the device comprising an engine that has been conformance tested using the method defined above.

In a final aspect, there is a computer program for use with a development environment for a target platform, the computer program enabling the method defined above to be performed on a desktop computer.

### BRIEF DESCRIPTION OF THE DRAWINGS

The present invention will be described with reference to the accompanying Figures, in which:

FIG. 1—illustrates the point that without CVM, high resource functions have unknown resource requirements, fuzzy behaviour, and non-standard inbound and outbound interfaces;

FIG. 2—illustrates the point that CVM engines have known resource requirements, conformed behaviour, standardised interfaces, making them genuinely commoditized components;

FIG. 3—shows that the CVM runtime provides resource management and scheduling, decoupling executives from engines;

FIG. 4—is a CVM design flow summary;

FIGS. 5 and 6 show how error terms can be represented;

FIG. 7 is a schematic showing the structure of a reference engine tester application;

FIG. 8 is a workflow diagram for developing a CVM engine;

FIG. 9 is a screen shot from RadioScape's System Designer IDE (Integrated Development Environment).

### DETAILED DESCRIPTION

1. Overview of the Communication Virtual Machine (CVM)

The CVM is a combination of run-time middleware and design-time tools that together help users implement a development paradigm for complex communication stacks.

The underlying conceptual model for CVM is as follows. We assume that a communication stack (particularly at layer 1) may be decomposed into:
High-resource, largely-application-neutral components, which will probably be implemented either in dedicated hardware or in highly platform-optimised software. These we call engines, and examples would be: FFT, FIR filter, vector multiply, etc. In the general case (where the particular CVM engine constraints are not met), we refer to such blocks as high-resource functions, or HRFs.
Low-resource, largely application-specific components, which will probably contain nothing that inherently binds them to a particular underlying hardware substrate. These we call executives, and examples would be the overall dataflow expression of a data plane, the acquisition and tracking logic in a supervisory plane, and the channel construction and deletion logic in a control plane. In the general case (where the particular CVM executive constraints are not met), we refer to such software as low-resource control code, or LRCC.
The real time operating system (RTOS), which partially shields the software from the underlying hardware platform.

Unfortunately, most system designs have tended to centre around a ‘silo’ paradigm, according to which assumptions about HRF implementation, resource usage, call format and behaviour have been allowed to ‘leak out’ into the rest of the design. This has led to a number of quite unpleasant design practices taking root, all under the banner of efficiency. For example, knowing how long various HRFs will take to execute (in terms of cycles), and how much scratch memory each will require, it often becomes possible for the system designer to write a static schedule for scratch, allowing a common buffer e.g. to be used by multiple routines that do not overlap in time, thereby avoiding potentially expensive and non-deterministic calls to malloc( ) and free( ). However, such a design also tends to be highly fragile; should any of the HRFs be re-implemented (causing a modification in their resource profiles and/or timings), or if the underlying hardware should change, or (worst of all!) if the stack should be compelled to share those underlying resources (including memory), with another stack altogether (the multimode problem), then it is a virtual certainty that a ground-up redesign will be called for. Silo development is the embedded systems equivalent of spaghetti programming (where the hardwiring is across the dimension of resource allocation, rather than specifically program flow), and with the advent of complex, packet based multimode problems, it has reached the end of its useful life.

1.1 CVM Makes HRFs into Engines

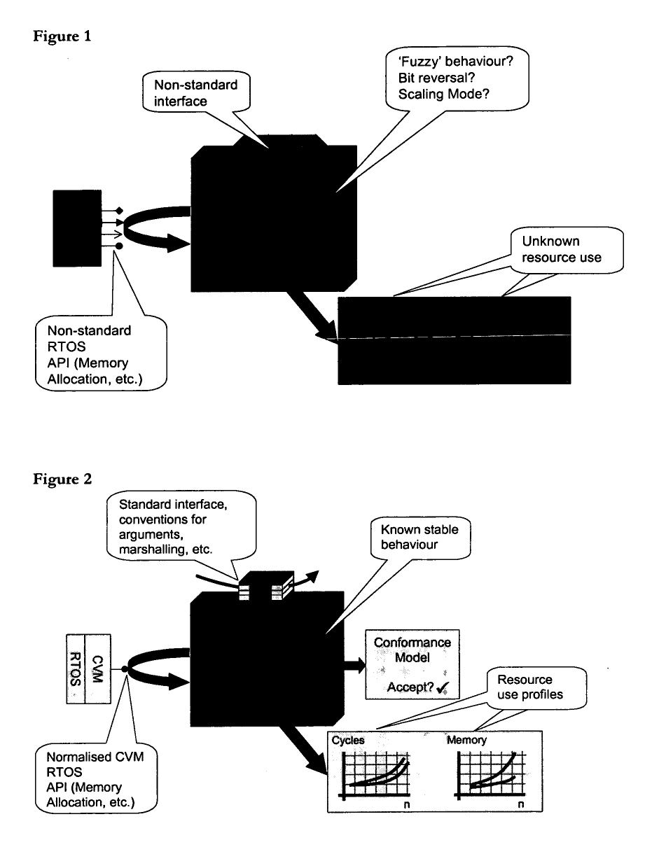

The first step away from silo development that CVM takes is in the area of HRFs (high-resource functions). In a typical wireless communications stack, nearly 90% of the overall system resources are consumed in such functions. However, in systems developed without CVM, HRFs (such as an FFT, for example), tend to be quite variable across different implementations. This is illustrated in FIG. 1.

The drawbacks here are:
Non-standard inbound API—calls to different vendors'FFT libraries are likely to utilise different argument lists, potentially even with different marshalling. This does not tend to promote interoperability.
Non-standard outbound API—different vendors'FFTs will probably require different services from the underlying RTOS, including memory allocation etc. Again, this tends to lower the extent to which they can be treated as commodities.
‘Fuzzy’ behaviour—everyone is pretty clear what a 16-bit IQ FFT should do, but there is still scope for considerable differences between implementation. For example, is bit reversal implemented? What about scaleback? Etc. Such differences in behaviour pose real problems for system designers.
Finally (and this is the most important for the present invention), unknown resource requirements. What will be the implications of calling this vendor's FFT in terms of memory (scratch and persistent), cycles, power, etc.? How will these requirements change as the size of the input vector changes? Without such data, published in a standard manner, intelligent scheduling becomes next to impossible.

CVM engines are HRFs with certain aspects standardized. This is illustrated in FIG. 2, above.

In comparison with the HRF case just considered, the CVM engine has the following attributes:
A standardised inbound API—meaning that all implementations of the FFT (for a given arithmetic model polymorph) will be called in precisely the same manner, regardless of underlying implementation.
Standard outbound API. In fact, engines are stipulated to have run-to-completion semantics within their thread domain (meaning that they never have to lock memory explicitly), and the only RTOS calls they may make are for dynamic memory allocation. Even then, it is strongly preferred that all of an engine's memory requirements be published up-front in its resource profile (see below), in which case no outbound interfaces at all are required for the engine implementer, who merely has to extract the necessary vector pointers to the arguments (and to any allocated scratch and persistent buffers), before (typically) dropping straight into assembler.
Known behaviour—all CVM engine implementations must be conformance tested against a ‘gold standard’ behavioural model—a reference engine—under an appropriate specification of equivalence. RadioScape publishes a number of standard models (i.e reference engines) (including, as it happens, a polymorphic FFT); developers may publish their own if required.
Finally, known resource requirements. All engines must have their resource usage profiled against at least cycles and memory for a range of vector dimensions and this information published as part of the component metadata. The resource requirements for memory should cover (explicitly) any required scratch and persistent memory, together with their formal parameter argument lists. Having this information available makes possible relatively accurate traffic-level simulation, as well as more intelligent run-time scheduling policies.
   1.2 CVM Executives May not Directly Call Engines

Of course, having these nicely standardised HRFs in the form of engines is only part of the solution. We have now isolated most of our system's expensive processing inside commoditized components (engines) with known behaviour, standard APIs and profiled resource usage.

Yet all this would be for naught, from a resource scheduling point of view, if we allowed engines to be called directly by the high level code. This is because direct calls would, more or less, determine the underlying execution sequence and also the threading model. The latter point is critical for an efficient implementation. Even worse, on our CVM model of an engine, the caller would be responsible for setting up the appropriate memory (of both the scratch and persistent varieties) for the underlying engine, thereby quickly landing us back with explicit resource scheduling.

The CVM therefore takes the approach that engines must be called only via a middleware service—the scheduler. The scheduler effectively exists as a single instance across all executive process and logical threads, and decides, utilising a plug-in scheduling policy, which of these are to be submitted for execution to the underlying RTOS, using how many RTOS threads, at what priority, at each logical timestep. This is shown conceptually in FIG. 3.

1.3 CVM Tools and Design Flow

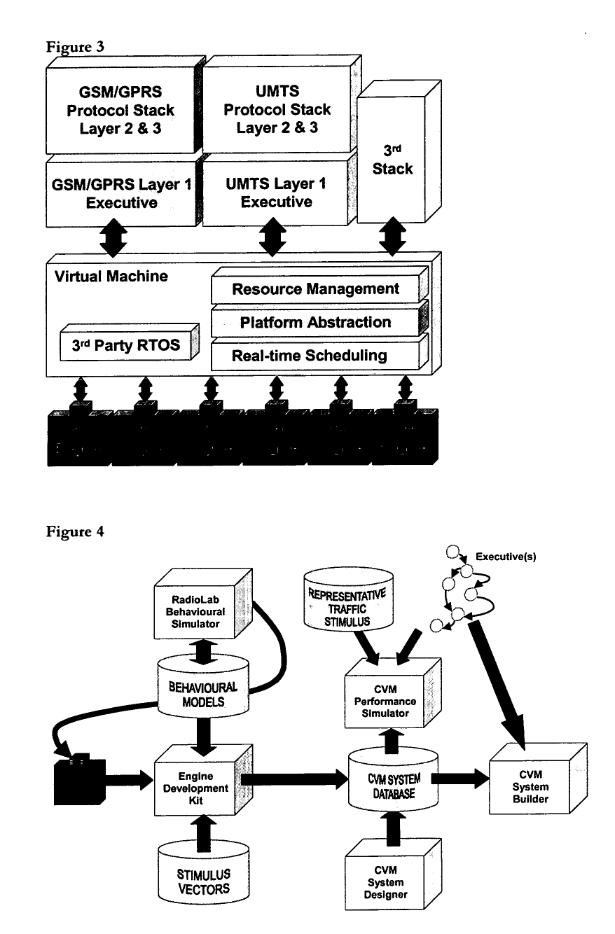

The overall design flow for the CVM is shown in FIG. 4. The RadioLab tool, using the polymorphic ‘gold standard’ reference versions of the various engines, is utilised to determine questions like the optimal bit widths for filters, likely performance of equalisers, etc. Then, a basic, high-level executive, not correct in all the details but with the vast majority of the necessary (and dimensioned, using the previous step) engine calls in place will be constructed, together with some representative traffic stimuli, and a candidate hardware platform will be selected.

In an extreme bottom-up flow, DSP engineers would then use the engine development kit (EDK), integrated with the appropriate DSP development tool (e.g., Visual DSP++) to construct optimised engines for all of the required HRFs in the system. These would be conformance tested against the gold standards and then performance profiled using the EDK.

For an extreme top-down flow, the same DSP engineers would simply publish their expected ‘forward declared’ performance profiles for the necessary engines, but would not actually write them. Reality is likely to lie somewhere between these two extremes, with the majority of needed engines either existing in engine form or requiring simply to be ‘wrapped’ and profiled, and with a few engines that do not yet exist (or have not yet been optimised) being forward declared.

Next, the designer would use the system designer to choose and deploy the appropriate number of instances of engine implementations against each required HRF from the executive. Then, a scheduling policy would be chosen using the system designer, and a traffic simulation executed. The results of this simulation would be checked against design constraints—and any mismatches would require either recoding of the ‘bottleneck’ engines, redesign with lowered functionality, or a shift in hardware platform or scheduler (and possibly a number of these).

Once a satisfactory result has been obtained (and multiple concurrent executives may be simulated in this manner), the executive developers can start to flesh out in more detail all of the necessary code inside the stack. As the executive is refined, traffic simulations should be continued to ensure that no surprising behaviour has been introduced (particularly where ‘forward declared’ engines have been used).

Finally, once all necessary engine implementations have been provided and the executive fully elaborated, an end deployment may be generated through the CVM system builder, which generates the appropriate runtime and also generates the makefiles to build the final system images.

2. Developing A Reference Engine

2.1 Bit True Engines

Essentially a reference engine, also called a Gold Standard Engine, (GSE) is a type dependent engine where the type T defines the numeric type to be used by an engine for its inputs, internal arithmetic, accumulator and outputs. For example, single precision floating point arithmetic may be used for the inputs to an engine, for the internal arithmetic and accumulator, and for the outputs from the engine. Alternatively, the type T used by an engine may, for example, be specified as fixed-point, with defined bit-widths, such as 16-bits for the engine inputs, 32-bits for internal arithmetic with a 40-bit accumulator, and 16-bits for the output. A type dependent engine using type T may not mix arithmetic types, i.e. if an engine performs single precision floating point arithmetic, it may not use any other arithmetic type, such as double precision floating point or fixed point. Specifically, type T defines that the arithmetic used by engine is of particular type, such as single or double precision floating point, or fixed point with a defined rounding and overflow mode, and precise input, internal, accumulator and output bit widths. The GSE will be written in C but crucially implemented in terms of fixed point Digital Signal Processor (DSP) recipes.

A candidate 3^{rd} party engine will be declared to be Gold Standard Compliant if it is functionally (rather than analytically) equivalent to the GSE in terms of the “bit trueness” of the engine using type T arithmetic. Hence, if the engine's arithmetic should change, such as the accumulator's bit-width increasing from 40 bits to 48 bits, then the engine must be re-tested for Gold Standard Compliance. Gold Standard Compliance will be determined after a set of input vectors returns a set of output vectors which fall within a given target range. If the input vectors to the GSE and a 3^{rd} party engine produce “equivalent” output, we say that the 3^{rd} party engine is compliant in a bit true way with the Gold Standard.

2.2 Engines

There are three classes of engines: those that are behaviourally defined, those that are numerically defined, and those that process stochastic data or process data subjected to statistical noise, i.e. there is a generally unobtainable ideal result equal to the input sequence before the application of noise/distortion processes.

For a numerical engine, the optimal or most correct result will be obtained using infinite precision arithmetic (i.e. can simultaneously handle very large and very small numbers with no loss of precision), and can be expressed as (xΞ_{ideal}y), where x and y are the input operands, and Ξ is the engine under consideration. Note that the result may be a scalar or a vector, and that the number of input operands may be more than the two used in the terminology here.

Since an implementation of infinite precision arithmetic is realistically unfeasible, using double precision floating point arithmetic will approach the result that may be obtained using infinite precision arithmetic, but with an inherent error. The result of executing an engine, Ξ, using double precision floating point arithmetic may be called (xΞy).

Since DSPs use a given numeric precision to perform arithmetic, some vendors define the result of an engine using double precision floating point arithmetic internally, but converting the resultant double precision floating point engine output, to the same numeric type, T, as used by a DSP (applying the relevant overflow and rounding modes). This result may be termed T(xΞy).

Our implementation of a GSE, however, will use arithmetic associated with type T throughout, and therefore, the result will deviate from that obtained using either of the above two arithmetics. This form of an engine may be given by (T(x)Ξ_{T}T(y)) and will define the minimal acceptable performance of an engine using arithmetic of type T.

However, unlike numerical engines, stochastic engines, such as a Viterbi decoder, have an ideal answer, (xΞ_{ideal}Y), which for a given implementation may possibly not be obtained, regardless of the arithmetic type used (including infinite precision). Nevertheless, it may be possible for an alternative implementation to approach this ideal answer more closely.

2.3 Behaviourally Defined

Behaviourally defined engines are those whose behaviour is deterministic, and that perform no mathematical operations that are dependent upon the precision used, i.e. its output is unaffected by the underlying precision and type.

For example, the interleaving process effectively transposes the contents of specified array elements with other specified array elements. Therefore, no type dependent arithmetic is performed (neglecting the array index variables), and the result is either correct or incorrect. Using the previously defined notation, the expressions, (xΞ_{ideal}y), (xΞy), T(xΞy), and (T(x)Ξ_{T}T(y)) will all be exactly the same, provided that the type T has sufficient precision and dynamic range to completely represent the test vectors, and we neglect the engine's internal loop and array element indices.

Thus, given a set of N test vectors, the Gold Standard Tester will be able to determine precisely for which test vectors the engine under test returns the correct result, and for which it returns an incorrect result.

2.4 Numerically Defined

Numerically defined engines are those whose behaviour is deterministic and whose functionality can be defined in terms of mathematical functions, and therefore the result is dependent upon the numeric type and precision used within the engine. For example, if we consider the calculation of the mean of a vector, deviation from the answer obtained using infinite precision arithmetic can arise from:
1. Associative laws, i.e. operator ordering, e.g. (2+2)−3, and 2+(2−3) will evaluate to different results if using three bit integers.
2. Distributive laws, i.e. a*(b+c) and a*b+a*c are numerically equivalent but can lead to precision problems when using finite precision arithmetic.
3. Limited precision leading to rounding issues.
4. Limited dynamic range leading to overflow issues.

For this class of engine, the expressions (xΞ_{ideal}y) and (xΞy) will not be the same, with (xΞ_{ideal}y) representing the mathematically perfect result, and (xΞy) representing the realistically achievable result obtained executing the GSE using double precision floating point arithmetic.

There will be cases when the error, ε_{d}, between the two results will be zero, and there will be situations when this error has a positive value. ε_{d} is defined as the absolute error between the resultant vector obtained using infinite precision arithmetic, and that obtained executing the GSE using double precision floating point arithmetic:
ε_{d}=|(xΞy)−(xΞ_{ideal}y)|₂.

However, executing the GSE in double precision floating point arithmetic, and converting the result to type T (applying the relevant overflow and rounding modes) may lead to a different result (dependent upon the input test), T(xΞy), where the error term, ε_{T}, may be non-zero, and may be determined thus:
ε_{T}=|T(xΞy)−(xΞ_{ideal}y)|₂.

Executing the engine using purely arithmetic of type T, i.e. (T(x)Ξ_{T} T(y)), will generally result in a different answer to both (xΞy) and T(xΞy), and the error term ε_{TT} will also therefore, generally be non-zero, where ε_{TT} is defined as:
ε_{TT}=|T(x)Ξ_{T}T(y))−(xΞ_{ideal y})|₂.

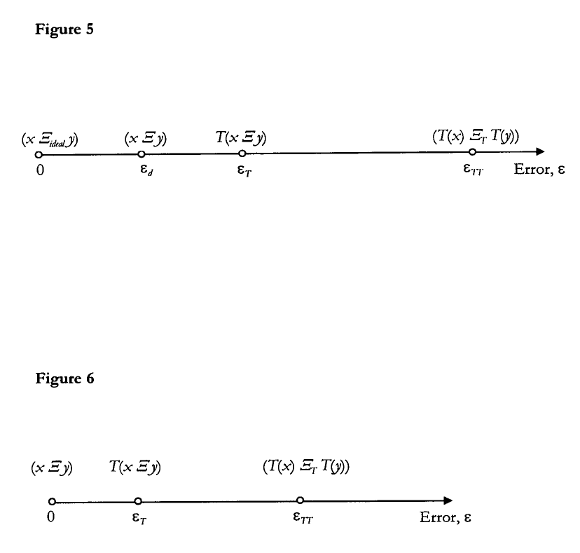

These error terms may be expressed graphically as shown in FIG. 5, which shows that the error associated with (xΞ_{ideal}y) is zero, not that the value of the vector (xΞ_{ideal}y) is zero.

In practice however, the result of a numerically defined engine is unknown for infinite precision arithmetic, and we must replace (xΞ_{ideal}y) by (xΞy), where the engine Ξ is executed using double precision floating point arithmetic. Hence, we must consider Ed to be zero (this is not strictly true but since we cannot evaluate (xΞ_{ideal}y), we must do so for numerically defined engines).

Therefore, ε_{T} becomes:
ε_{T}=|T(xΞy)−(xΞy)|₂,
and ε_{TT} becomes:
ε_{TT}=|T(x)Ξ_{T}T(y))−(xΞ_{ideal}y)|₂,
and the FIG. 5 diagram evolves into the FIG. 6 diagram.

The error associated with a third party's implementation, ε_{3rd party}, must fall between 0 and ε_{TT}, which is the error associated with the minimal acceptable performance when using type T In other words, since our implementation of the engine using type T is the minimal acceptable performance of an engine using arithmetic of type T, the performance of a 3^{rd} party's implementation of a given engine using arithmetic of type T, must lie between that obtained using double precision floating point arithmetic, and that obtained using our Gold Standard implementation, in order for the engine to be termed “Gold Standard Compliant”.

Hence, a 3^{rd} party engine may be declared to be “Gold Standard Compliant” for type T if 0≦ε_{3rd party}≦ε_{TT}, for all test vectors, where ε_{3rd party} is defined, for numerical engines, as:
ε_{3rd party}=|T(x)Ξ_{T, 3rd party}T(y))−(xΞy)|₂.
2.5 Stochastic Engines

Stochastic engines are those whose behaviour may be defined, but is data dependent at run-time, and the performance of the engine on a given set of data is internal arithmetic type dependent. An example of such an engine is a Viterbi decoder, where the behaviour of the engine is defined, but the operation of the engine is data dependent, and the performance (in terms of resultant Bit Error Ratio) is dependent upon the internal arithmetic used (the number of bits used for soft decoding).

The common performance metric of a Viterbi decoder engine is Bit Error Ratio (BER), which is similar in principle to measuring the error between the output sequence and the desired output sequence (the error free sequence originally fed into the channel encoder). Hence, we can use the same error metrics as for behaviourally and numerically defined engines.

The ideal result of a stochastic engine is a known set of values, such as the input vector to a channel encoder (called the source vector). In order to evaluate the performance of the associated channel decoder, the output from the channel encoder must be corrupted, and fed into the channel decoder, with the aim of obtaining the original source vector at the output of the decoder. Hence, the ideal result is the original source vector. Another example is the known multipath channel that is estimated using channel estimator engines, where again the ideal result is an input vector to the channel modelling process.

This ideal result, defined as (xΞ_{ideal}y) is generally unobtainable, though it may be approached to a given point. Since this ideal result is generally unobtainable, the “best” result that may be obtained using a given engine is achieved with double precision floating point arithmetic, and is termed (xΞy). The result obtained using type T throughout the engine, Ξ, is (T(x)Ξ_{T}(y)).

For behaviourally and numerically defined engines it is necessary to use the engine result obtained using double precision floating point arithmetic as the baseline performance. However, for stochastic engines it is conceivable that a derivative of a given engine is developed which exceeds the performance of our engine using double precision floating point arithmetic, and approaches the ideal result more closely, and therefore the baseline must be the original source vector, i.e. (xΞ_{ideal}y). Therefore, for stochastic engines the error calculations are given as:
ε_{d, stochastic}=|(xΞy)−(xΞ_{ideal}y)|₂,
ε_{T, stochastic}=|T(xΞy)−(xΞ_{ideal}y)|₂,
ε_{T, stochastic}=|(T(x)Ξ_{T}T(y))−(xΞ_{ideal}y)|₂,
ε_{3rd party, stochastic}=|(T(x)Ξ_{T, 3rd party}T(y))−(xΞ_{ideal}y)|₂,
and for a 3^{rd} party's engine to be declared as “Gold Standard Compliant” the following condition must be satisfied, for all test vectors:
0≦ε_{3rd party, stochastic}≦ε_{TT, stochastic.}
2.6 Gold Standard Compliance Test Vectors

There will be two different types of test vectors used to determine whether an engine is Gold Standard Compliant. The first set of test vectors will be individually designed to test specific situations that the engine may encounter. These situations will include:
1. Input boundary cases; the input vector(s) will include boundary case values, e.g. most positive number, most negative number, least positive number and least negative number.

2. Internal boundary cases; the input vector(s) will be defined such that they will cause boundary case values to be encountered during the engine's internal processing.

3. Output boundary cases; the input vector(s) will be defined such that they will cause boundary case values to be encountered in the result of the engine's execution.

4. Internal underflow and overflow; the input vector(s) will be defined such that they cause underflow and overflow conditions to be encountered during the internal processing.

5. Stuck at faults; the input vector(s) will be defined such that every bit used to represent a value will be tested for stuck-at-0 and stuck-at-1. This testing strategy is more commonly employed in digital circuit design, such as FPGAs but may prove useful to include.

6. Special cases are engine dependent; the input vector(s) will be defined to test particular engines, to determine their capability to handle special inputs that can lead to incorrect answers. For example, there are certain sequences for which a fixed-point FFT may fail, but a floating point FFT may function correctly.

The second set of test vectors will be generated on-the-fly by the Gold Standard Engine Tester software, using a seeded pseudo random sequence generator, and may consist of thousands of test vectors, each of which will be passed through the Gold Standard Engine and the 3^{rd} party engine, in order to determine whether Gold Standard Compliance has been achieved. The use of a seeded pseudo random number generator will allow the same test vectors to be repeatedly generated, without having to store the test vectors themselves; only the seed need be stored. The seed will have a default value, but may be altered by the user to alter the set of test vectors used.

For both sets of test vectors, a compliance report will be generated after the testing has been completed. This report will include the number of test vectors for which compliance was achieved, and for which it was not, and will list those test vectors on which it failed.

The first set of test vectors will be primarily dependent upon the type T used for the engine's arithmetic, and as such the boundary values may be generated from the knowledge of the input, internal, accumulator and output bit-widths when using fixed point arithmetic, for example.

The second set of test vectors is not strictly dependent on the type T, but the values of the test vectors may need to be scaled to enabled the full dynamic range of the types to be exploited.

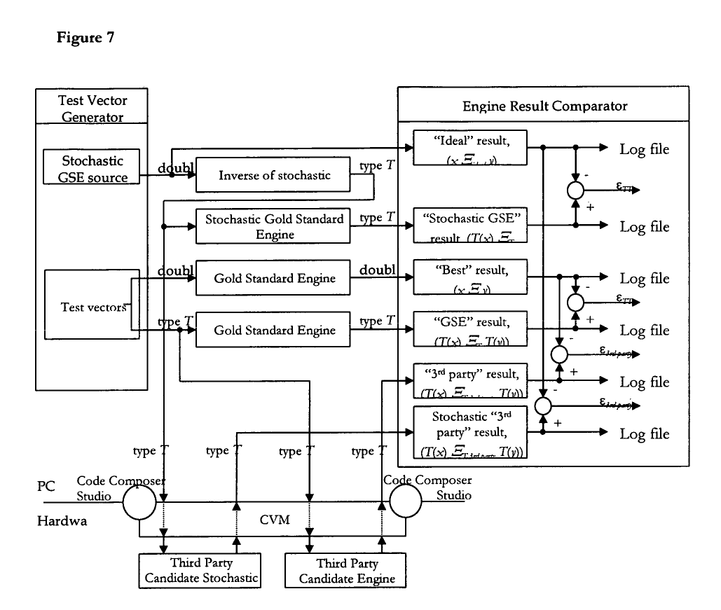

As shown in FIG. 7, for behaviourally and numerically defined engines the test vectors will be generated as double precision floating point values, and the GSE will be executed on these double precision floating point test vectors, using double precision floating point arithmetic, i.e. (xΞy) will be evaluated. The GSE will also be executed using the test vectors converted to type T, and internal arithmetic of type T, thus obtaining (T(x)Ξ_{T}T(y)). Therefore, the error, ε_{TT}, between our GSE using double precision floating point arithmetic, and our GSE using arithmetic of type T may be determined. The 3^{rd} party engine will then be executed using type T arithmetic, and the error, ε_{3rd party}, between (T(x)Ξ_{T, 3rd party}T(y)) and (xΞy) evaluated. If this error, ε_{3rd party}, is less than ε_{TT}, for all test vectors, then the 3^{rd} party engine will be declared as Gold Standard Compliant.

The test vectors for stochastic engines will also be generated as double precision floating point values, due to the distortion processes involved in the test vector generation. For example, the input signal to a Viterbi decoder may be a binary signal, from a channel encoder, corrupted by thermal noise and therefore, must be represented using double precision floating point values. However, when evaluating the GSEs and 3^{rd} party engines using arithmetic of type T, the test vectors will be converted to type T The ideal result, (xΞ_{ideal}y), from a GSE such as a Viterbi decoder, will be the source vector that was encoded, for decoding by the Viterbi decoder, and therefore will be available for comparison purposes. Note that in FIG. 1 the engine that performed the channel encoding, for example, has been termed the “Inverse of stochastic GSE”. The error, ε_{TT}, obtained by passing the test vectors through the engine using arithmetic of type T, can then be generated, in conjunction with the error, ε_{3rd party}, achieved using the 3d party's engine. Again, if this error, ε_{3rd party}, is less than ε_{TT}, for all test vectors, then the 3^{rd} party engine will be declared as Gold Standard Compliant.

The Gold Standard Tester application will write to a log file, the list of the test vectors for which the 3d party's engine achieved Gold Standard Conformance, and the list of test vectors for which Gold Standard Conformance was not achieved

Appendix 1

User Guide for CVM Engine Developers v 2.0

The aim of this Appendix 1 is to describe how you go about developing a CVM engine, so that it can become a fully functioning component of a CVM system.

The content is aimed at DSP programmers developing HRFs (High Resource Functions), such as FFTs, Viterbi encoders/decoders and FIR Filters.

So, what is a CVM engine? In simple terms it is a standardised set of files, including an executable, that performs an HRF. Put like this, there doesn't seem to be anything particularly remarkable about an engine. The power of an engine, though, comes from the fact that the infrastructure code that handles memory management and communication with the client code that needs to make use of the HRF is generated automatically—you can leave this peripheral functionality to the engine while you concentrate on writing the code that performs the HRF.

The role of the engine does not end with providing the infrastructure for your HRF development. Once you've written your code, you'll want to test it to make sure it does what you want it to do. Normally this is a rather expensive process, but with CVM you can test your engine for conformance to a standard to ensure that the results are correct before you go any further.

The standard against which you test an engine for conformance is known as a reference engine. A reference engine is a version of the same functionality you would expect to find in an engine, but instead of running on your DSP it runs on a Windows PC. You can write a reference engine to be polymorphic in that any given type can be quite general (such as an integer instead of a 16-bit signed integer array or an 8-bit unsigned scalar, for instance). This polymorphism of the data types enables you to create many engines from a single reference engine—as long as each explicit data type in the engine fits into the polymorphic definition of its associated data type in the reference engine, the engine is capable of reproducing the functionality of the reference engine.

We have, though, missed something in going straight from reference engines to engines. In between the two, forming an interface between reference engine and engine, is an engine interface. There are two basic steps in going from a reference engine to engine that illustrate the part that an engine interface plays in CVM:
1. Create an engine interface based on a reference engine in order to fix the data types.
2. Create an engine based on an engine interface in order to fix the target platform.

You can think of an engine interface as a template for engines. From an engine interface you can create an engine for a particular platform, taking from the engine interface its explicit data type definitions.

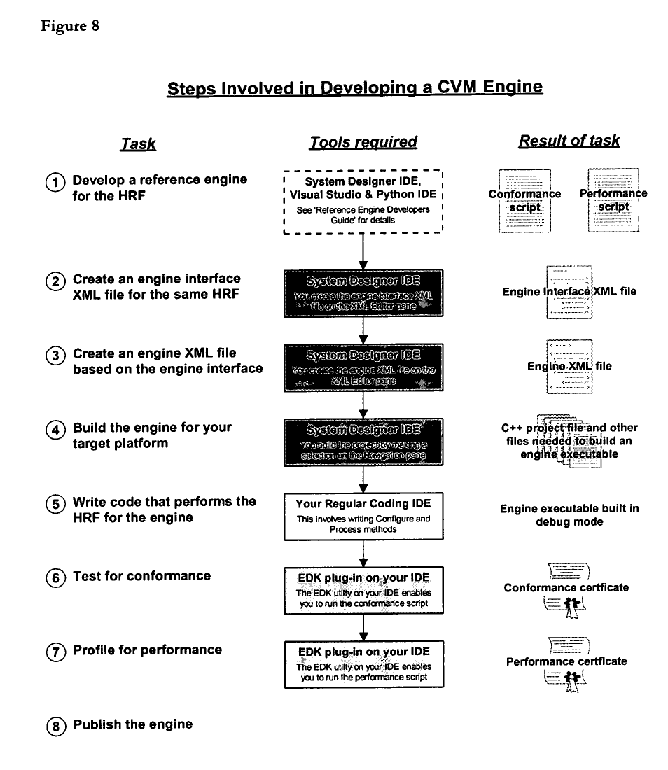

The first step of the workflow diagram FIG. 8 the page is the development of a reference engine.

The case we're presenting in this diagram is the perhaps ideal one where you start off with a reference engine, and then create your engine interface and engine from that reference engine. This workflow might not meet your requirements, especially if you already have engine-based functionality that you are satisfied with and want to enclose this functionality in a CVM engine. In such a scenario you are free to create your engine interfaces and engines with no association to a reference engine at all. This means that you will not be able to test your engines for conformance and performance, but this won't be a problem for your if you are already comfortable with the capabilities of the algorithms that you intend to wrap up as engines.

In this guide we largely follow steps in the diagram FIG. 8 to describe how you develop an engine, and hence we concentrate on the scenario where you have a reference engine that your engines must comply with. If you don't intend to work with reference engines, your task is simpler in that you can create your engine interfaces and engines from scratch, so some of the instructions in this guide will not be relevant to you.

Let's look at each of the steps above in turn. Here we'll assume that you already have a reference engine and accompanying scripts for the HRF you want to model.

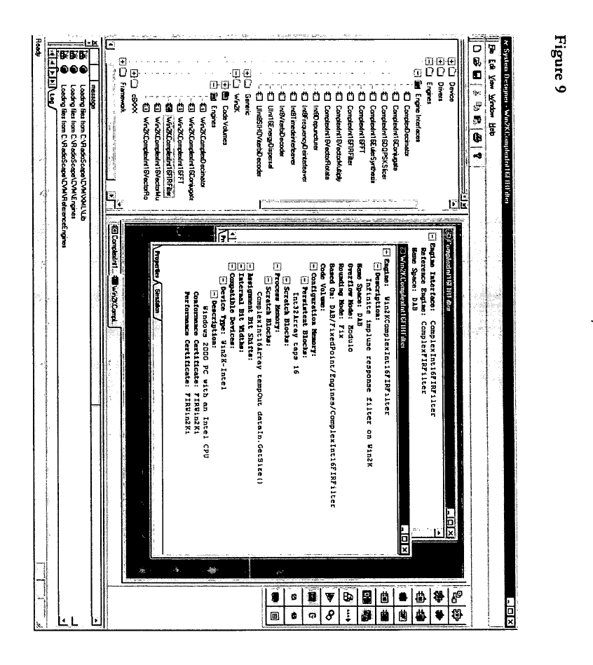

Step 2 is the creation of an XML file containing details of the engine interface for the HRF. You accomplish this step, and the two steps that follow it, on RadioScape's System Designer IDE (Integrated Development Environment), and example of which is shown at FIG. 9.

The central window here is an editor for XML files. In this example we see an engine interface XML file (ComplexInt16FIRFilter) in the background and an engine XML file (Win2KComplexInt16FIRFilter) in the foreground. Creating your own XML files in this window is straightforward because the System Designer generates a skeleton XML file for whichever CVM element (such as an engine or engine interface) you want to produce. You simply fill in the fields where necessary.

For an engine interface the details in most of the fields will be taken from the reference engine the interface is based on. All you really need to do is to replace polymorphic types for the two main methods, Configure and Process, with true types. For instance, if there is just one polymorphic type, T1, which represents integer arrays, you might want to replace this with type Int16Array, which represents 16-bit integer arrays.

Perhaps a better way of looking at the way types operate in CVM is that they are really dependent on the hardware and it is the details of these types that you specify in the engine interface XML. If you then have a reference engine containing polymorphic representations of these types, you can then run the reference engine and select the engine on which to base the run-time behaviour, so that the reference engine inherits the characteristics, especially the typing, from the engine interface and is consequently able to simulate the engine's behaviour.

Step 3, to create an XML file containing details of the engine, is also done on the System Designer. Since a new engine must be based on an engine interface, most of the fields for an engine XML file are initially taken from the engine interface XML. You simply specify the platform you want to target the engine for.

Step 4 is the building of a C++ project from the engine XML. From your point of view this is a trivial task, involving the selection of a single menu option for the engine, but for the System Designer it involves generating a set of stub files that form the basis for the C++ project in which you are to write the processing of the HRF you are modelling.

Step 5 is the most labour-intensive part of the process. This is where you write the code that actually performs the HRF on the target platform. You do this coding on your regular DSP coding IDE, but to facilitate this CVM comes with an extensive set of API functions.

Step 6 is the testing of your engine to assess whether or not it conforms to the reference engine representation of the HRF functionality. You do this testing by invoking the EDK (Engine Development Kit) utility that plugs in to your regular coding IDE. When you select the conformance option on EDK for a particular engine, EDK runs the conformance script for the reference engine that the candidate engine is based on, which means that all the tests in that script are applied to the candidate engine. If the engine fails any of the tests, it is deemed not to conform. If it passes all the tests, the candidate engine becomes a conformed engine, and is issued with a conformance certificate stating this.

Step 7, the profiling for performance, is very similar to testing for conformance, at least in the way you carry out the profiling. From EDK on your regular coding IDE you can choose a performance option for an engine that you select, which causes EDK to run the performance script for the reference engine that the conformed engine is based on. By running this script EDK records various performance indicators for the engine, in terms of processor efficiency and memory loading. These details are recorded on a performance certificate, which gives you a profile of the performance characteristics of the engine

Step 8, the final step, is the publishing of the engine. This involves making that engine widely available so that it can be plugged into any CVM system.

Conformance Testing Your Engine

Although you can create an engine independently of a reference engine, if you want to be able to run tests that judge the correctness of the functionality of an engine, you must base the engine interface for your engine on a reference engine.

So, what exactly is a reference engine? In basic terms it is a polymorphic fixed-point bit-true behavioural description of an engine that runs on a PC. It provides the definitive statement of functionality for the type of engine you have been developing. Effectively, then, it is a behavioural version of your engine.

Part of the process of developing a reference engine is to create a conformance test script to go with it. This script, which is written in the interpreted language, Python, should contain a set of tests designed to establish whether or not an engine conforms to the standard behaviour of the reference engine. These tests involve identical Configure and Process call sequences on the same data. A candidate engine, that is, an engine that you want to conform, must pass all the tests to become a conformed engine.

You run the conformance tests from your own DSP coding IDE (Integrated Development Environment) through a plug-in utility that we provide, the Engine Development Kit (EDK). If an engine you choose with EDK passes all the tests, CVM issues the engine with a file that shows the tests that have been passed. This file is known as a conformance certificate, since it certifies that your engine now conforms to a polymorphic standard.

Attributes for Conformance Certificate XML

The tags and attributes that are used in the conformance certificate XML file are explained in this section.

ConformanceCertificate

This tag is a container tag, which frames the conformance certificate description. The tag has a number of attributes, which are listed below. Additionally it will contain Signature and MetricTable tags.

Name

The name of the conformance certificate. This is identical to the name of the engine being tested for conformance.

Description

Describes what the conformance certificate is for.

Date

Gives the date when the conformance certificate was generated.

Script

Gives the name and location of the script that was used for conformance testing. This script will have been supplied to you by the reference engine developer.

Result

Briefly states the result of the conformance test—whether the engine passed of failed the test. If an engine failed the test, details of exactly which part of the test failed will generally be listed in the log file as shown below.

Logfile

Gives the name and location of the log file generated when the conformance test was run. The log file will contain conformance test details; exactly what is listed in the log file will depend on the conformance test script supplied to you by the reference engine developer.

Signature

This frames the PGP (Pretty Good Privacy) signature used to ensure that the conformance test is valid.

PGPSignature

The PGP (Pretty Good Privacy) encrypted signature is used to ensure that the conformance test is valid. This is an important safeguard, enabling engine packages to be sold to third parties.

MetricTable

This is a container tag. It frames the metrics for one particular conformance test. The tag has a number of attributes, which are listed below. Additionally it will contain Entry tags.

The metric table is the place where the reference engine developer will place details about their engines algorithmic performance in addition to the simple pass/fail recorded in the Result attribute of the Conformance Certificate tab above.

ParameterName

The name of the parameter that the reference engine developer has chosen to vary in order to examine the result metric.

ResultName

This is the result metric.

Entry

This tag must be contained within a metric table tag. It contains the results for a single entry in the metric table. This tag has a number of attributes. It contains a parameter value and the value of the result metric at that parameter value.

ParameterValue

This is a value of the parameter specified in ParameterName.

ResultValue

This is the value of the result metric at the given parameter value.

Appendix 2: CVM Definitions

The following table lists and describes some of the terms commonly referred to in this Detailed Description section. The definitions cover the specific implementation described and hence should not be construed as limiting more expansive definitions given elsewhere in this specification.

| Term | Description |
|---|---|
| ASIC | Application-Specific Integrated Circuit. |
| | An integrated circuit designed to perform a particular |
| | function by defining the interconnection of a set of basic |
| | circuit building blocks, which are taken from a library |
| | provided by a circuit manufacturer. |
| Assembly | An assembly of devices, derived devices, other assemblies |
| | and buses, which defines their connectivity. |
| Baseband | A telecommunication system in which information is |
| | superimposed, where the frequency band is not shifted |
| | but remains at its original place in the electromagnetic |
| | spectrum. |
| Behavioural Simulator | A simulator that allows a developer to explore how a |
| | particular function may perform within a system but |
| | without actually generating the detailed design |
| | configuration (in the case of a DSP, its software) for the |
| | target device. A behavioural model ensures that inputs |
| | and outputs are accurate but the internal implementation |
| | is created in a different way to the hardware it is |
| | attempting to model. RadioScape's initial behavioural |
| | simulator is the RadioLab3G product that supports the |
| | W-CDMA FDD standard. |
| Bit True | Accurately reflecting the behaviour of a particular |
| | implementation. Every bit of data output is identical to |
| | that which would be generated by a hardware |
| | implementation of the function being modelled. |
| CSV | Comma Separated Values. |
| | Text based format for a data file with fields separated by |
| | commas. |
| CVM | Communication Virtual Machine ™. |
| | RadioScape's CVM methodology produces a Runtime |
| | Kernel that handles resource management, hardware |
| | abstraction and scheduling. The CVM Runtime Kernel is |
| | deployed through the use of RadioScape's CVM Toolset. |
| COM | Component Object Model. |
| | Microsoft's mechanism to allow one piece of software to |
| | call services supplied by another, regardless of their |
| | relative locations. Usually distributed as DLL files. |
| Conformance Test | A test to establish whether an implementation of an |
| | Engine matches the functionality of its Reference engine |
| | behavioural equivalent. |
| | This test is executed by the EDK as a plug-in to the |
| | semiconductor vendor supplied integrated development |
| | environment. Both the particular fixed-point polymorph |
| | of the behavioural model and the proposed |
| | implementation are simulated with the same stimulus |
| | vectors and the results compared. In some cases the |
| | comparison is a simple matching of numbers whereas in |
| | others it is necessary to evaluate whether the |
| | implementation equals or betters the performance of the |
| | behavioural equivalent. |
| CVMGen | A tool in the CVM family for generating stub code for |
| | engines. |
| Cycle Accurate Simulator | A simulator that is dedicated to accurately modelling the |
| | behaviour of a particular hardware implementation. The |
| | data output is accurately represented at each clock cycle |
| | and contains knowledge of the impact of cache memory, |
| | pipeline and look-ahead, etc. This type of simulation, by |
| | its very nature, takes requires considerable processing |
| | power to perform and so is only suitable for short |
| | simulation runs. |
| Data Type | The data type that can be used by a parameter. |
| Deployment | A Layer-1 system based on the CVM Runtime Kernel |
| | which can be developed using the CVM Toolset. |
| DLL | Dynamic Linked Library. |
| | A type of library that becomes linked to a program that |
| | uses it only temporarily when the program is loaded into |
| | memory or executed rather than being permanently built |
| | in at compilation time. |
| Dorsal Connection | Control Input connection on Planes or Modules |
| DSP | Digital Signal Processing |
| | Computer manipulation of analogue signals that have |
| | been converted to digital form (sampled). Spectral |
| | analysis and other signal processing functions are |
| | performed by specially optimised Digital Signal |
| | Processors. Digital Signal Processors are super versions |
| | of RISC/maths co-processors in VLSI (Very Large Scale |
| | Integration) chip form, although they differ from maths |
| | co-processors in that they are independent of the host |
| | computer and can be built into a standalone unit. Like |
| | RISC, they depend on a small core of instructions that |
| | are optimised at the expense of a wider set. They are |
| | often capable of special addressing modes that are unique |
| | to a particular application. |
| Engine | A particular type of high resource function that has been |
| | Conformance tested and Performance profiled with |
| | EDK. |
| | Such a function usually consumes significant processor |
| | cycles and/or memory; common examples include a Fast |
| | Fourier Transform, Finite Input Response Filter and |
| | Complex Vector Multiply. Specifically an Engine is |
| | invoked in a standardised way and with a standardised |
| | approach to data marshalling. Access to RTOS functions |
| | is normalised through RadioScape's CVM Runtime |
| | Kernel. An Engine runs an Algorithm to implement a |
| | particular transform. An Engine is the lowest level of |
| | code class element within the RadioScape programming |
| | model for Layer-1. |
| Engine Co-Class | The Engine Co-Class is responsible for passing requests |
| | through to the underlying implementation, while also |
| | ensuring that, for example, all appropriate memory |
| | allocation invariants are met. It conforms to the Engine |
| | Type interface. |
| EDK | Engine Development Kit. |
| | RadioScape's tool for introducing new Engines to the |
| | RadioScape environment. Configured as a plug-in to the |
| | semiconductor vendor's code development tool. |
| | Certifies the Conformance to a polymorphic ‘gold’ |
| | standard behavioural model and Performance |
| | characteristics of an Engine. Following performance |
| | testing the characteristics may be substituted for low- |
| | level simulation within the Stochastic Simulator. |
| Engine Interface | The Engine Interface describes the format of the calls |
| | that the engine must handle. |
| FFT | Fast Fourier Transform. |
| | An algorithm to convert a set of uniformly spaced points |
| | from the time domain to the frequency domain. |
| FIR | Finite Impulse Response. |
| | A type of digital signal filter, in which every sample of |
| | output is the weighted sum of past and current samples |
| | of input, using only a finite number of past samples. |
| Fixed Point | A number representation scheme in which a fixed |
| | number of bits are used to represent a numerical value. |
| | Calculations using this method are subject to inaccuracy |
| | due to the difference between approximate |
| | representations with a limited number of bits turning |
| | every number, including fractions, into integers. |
| | This mode is important on the RadioLab3G tool since it |
| | enables the behavioural models to more accurately |
| | represent the limitations of the physical implementation. |
| Flip Flop | A digital logic circuit that can be in one of two states, |
| | which its inputs cause it to switch between. |
| Forward Declared Engines | The process of providing the Performance Certificate for |
| | an engine, together with estimated values, in order to |
| | perform stochastic simulation before engine construction |
| | is complete. |
| | Once engine construction is complete, the forward |
| | declared Engine can be replaced by a Performance |
| | Certificate derived from a real engine implementation. |
| FPGA | Field-Programmable Gate Array. |
| | A gate array, where the logic network can be |
| | programmed into the device after its manufacture. It |
| | consists of an array of logic elements: either gates or |
| | lookup table RAMs (Random Access Memory), flip-flops |
| | and programmable interconnect wiring. |
| Framework | A framework is a CVM Layer-1 application specific |
| | development. It may consist of a set of planes, modules |
| | and/or engines. |
| Reference engine Blocks | Polymorphic Fixed Point Bit-true Behavioural |
| | descriptions of high resource functions. |
| | These are effectively the behavioural versions of Engines. |
| | These Blocks come with a set of test vectors for |
| | Performance Testing and Conformance testing. A block |
| | is considered the Reference engine as it is used as the |
| | definitive statement of functionality. |
| Hardware End-Points | A hardware Engine is a dedicated physical |
| | implementation designed to perform a specific high |
| | resource function. Engines can be implemented in either |
| | hardware or software. Such an Engine may handle either |
| | Streaming implementations where data is continually |
| | processed without intervention, or Block implementation |
| | where fixed amounts of data are processed in each |
| | activation. RadioScape describes the necessary interfaces |
| | to be created to treat the block as a ‘hardware endpoint’. |
| | Such an end point may be substituted at a design time |
| | with either hardware or software implementations of an |
| | Engine. |
| Hardware-in-the-loop | At any point in either Engine or System Development |
| | behavioural or cycle accurate simulation models may be |
| | replaced by physical implementations of Engines running |
| | on representative silicon. |
| HRF | High Resource Function. |
| | A function within a Layer-1 implementation that has |
| | been identified as consuming substantial systems |
| | resources, usually processor cycles, and/or memory. |
| | Common examples include a Fast Fourier Transform, |
| | Finite Input Response Filter and Complex Vector |
| | Multiply. These functions are not usually specific to the |
| | wireless standard being implemented. An HRF that has |
| | been conformance and performance tested within EDK |
| | is referred to as an Engine. |
| IDE | Integrated Development Environment. |
| | A system that supports the process of developing |
| | software. This may include a syntax-directed editor, |
| | graphical entry tools, and integrated support for |
| | compiling and running software and relating compilation |
| | errors back to the source. |
| Inflate | This engine method enables you to give an identifying |
| | name for an allocation of memory along with the size |
| | you want the memory block to be. CVM can then track |
| | this memory so that you don't have to worry about it. |
| Layer-1 | First layer of the OSI seven layer Model. |
| | Layer-1 is the physical layer relating to signalling and |
| | modulation schemes. Typically in modern wireless |
| | standards these are implemented in digital signal |
| | processor devices (DSPs) and so will have high software |
| | content. |
| MIPS | Million Instructions Per Second. |
| | The unit commonly used to give the rate at which a |
| | processor executes instructions. |
| Module | Modules are aggregation elements that can contain an |
| | arbitrary number (>=0) of (sub-) modules and engines. |
| | Modules contain code, which can invoke these contained |
| | components, but which itself does not consume |
| | significant system resources, and so may be written in |
| | platform-independent C++. Data processing within a |
| | module runs imperatively once started, and the CVM |
| | runtime guarantees that at most one thread will ever be |
| | active within a given plane instance at any time. Modules |
| | have access to a more sophisticated memory model than |
| | engines, and may also send and receive control messages. |
| Parameter | One of the items of data that passes into or out of an |
| | engine. |
| Performance Certificate | Digital certificate that references an associated CSV file |
| | that holds a set of resource usage characteristics under |
| | different conditions for particular physical |
| | implementations of a high resource function. |
| | This data is generated by the Performance Test. |
| Performance Test | The aim of the performance test is to create a |
| | Performance Certificate that can be used with the |
| | Performance Simulator. The test involves executing a set |
| | of stimulus vectors against an Engine under test and |
| | recording the results. The test vectors aim to build up a |
| | set of points on a multi-dimensional surface that can later |
| | be interpolated to make useful estimates of execution |
| | time and resource usage. A key parameter, say data |
| | length, will be varied and the number of cycles recorded |
| | at each point. Key variables may be expanded to provide |
| | data for other variables such as bus loading, or other |
| | shared resources so creating a multi-dimensional profile. |
| | During Simulation the best estimate for resource |
| | utilisation is found by looking up the appropriate closest |
| | matches within the performance certificate and |
| | interpolating the result. This process is performed within |
| | the EDK plug-in. |
| Plane | Planes are top-level synchronisation objects that contain |
| | a single module, and which communicate using |
| | asynchronous message passing. |
| Plug-in | A small program that adds extra function to some larger |
| | application. EDK operates as a plug-in to the vendor's |
| | development tool environment. |
| Policy | A policy is used by schedulers to schedule data |
| | processing. |
| Polymorphic | Functions that can be applied to many different data |
| | types. Used in this context to indicate the ability of |
| | behavioural blocks to operate at different bit widths |
| | internally and externally, and have different overflow |
| | behaviours. This is valuable in allowing behavioural |
| | models to more accurately represent the physical |
| | implementation. |
| PPO | Parameter Passing Option. |
| | These stipulate the seven main ‘modes’ in which a |
| | parameter may be passed into a method (namely: in, |
| | inout, out, incast/outcast, infree and inshared and |
| | outalloc). Core types T and arrays of core types can be |
| | passed as method arguments. |
| Python | A freeware interpreted Object Oriented Scripting |
| | Language used for creating test scripts of Performance |
| | and Conformance testing and the Stimulus for Stochastic |
| | Simulation. See http://www.python.org |
| RadioLab3G | RadioScape's behavioural simulator supporting the |
| | W-CDMA FDD radio interface. The tool is based on |
| | Matlab/Simulink and uses the same ‘Gold’ standard |
| | blocks as the EDK conformance tool. |
| Rake | Digital section of a CDMA receiver which permits |
| | receiver to separate out the relevant signal from all the |
| | other signals. |
| RTOS | Real Time Operating System. |
| | A class of compact and efficient operating system for use |
| | in embedded systems. Relevant examples include DSP |
| | BIOS, OSE, Virtex and VDK. The CVM Runtime |
| | Kernel normalises the presented functions of common |
| | RTOS products so that Engines can operate in a number |
| | of environments. |
| Re-entrant | Code that has multiple simultaneous, interleaved, or |
| | nested invocations, which do not interfere with each |
| | other. |
| Resource | The quantity of a resource type a specific element has. |
| RISC | Reduced Instruction Set Computer. |
| | A processor where the design is based on the rapid |
| | execution of a sequence of simple instructions rather |
| | than a large variety of complex instructions. Features |
| | which are generally found in RISC designs are: uniform |
| | instruction encoding, which allows faster decoding; a |
| | homogenous register set, allowing any register to be used |
| | in any context and simplifying complier design; and |
| | simple addressing modes with more complex modes |
| | replaced by sequences of simple arithmetic instructions. |
| Runtime | CVM Runtime is made up of both standard CVM |
| | Runtime components and application-specific, |
| | components designed by you. The standard CVM |
| | Runtime components provide the core Runtime |
| | functionality, common to all CVM applications. |
| SDCL | System Development Class Library. |
| | Allows users to build modules and planes, and then |
| | combine these into a system framework. It also provides |
| | an RTOS abstraction layer. |
| Simulation Run | The results of simulating a particular deployment using |
| | the simulator. |
| Stateful | To avoid context switching, RadioScape's Engines are |
| | stateful. This means they preserve their state information |
| | from one invocation to the next. Accordingly, it is not |
| | necessary to reconfigure parameters or prime data when |
| | the function is called. |
| Stochastic Scheduling | The use of statistical information harvested at design |
| | time during a Training Run that enables runtime- |
| | scheduling decisions to be made more efficiently at |
| | runtime. |
| Stochastic Simulation | A type of simulation where certain functions rather than |
| | being modelled at a low granularity are replaced by |
| | statistically based estimates of time and resource usage. |
| | The resulting output while not data accurate is useful in |
| | understanding complex system performance in a short |
| | elapsed time simulation run. The Stochastic Simulator is |
| | part of the CVM System Development Kit. |
| UE | User Equipment. |
| | 3G terminology that emphasises that future user devices |
| | may not be simple voice handsets but may take different |
| | forms; wrist phone, car navigation device, camera, PDA, |
| | etc. |
| Ventral Connection | Control output connection on Planes and Modules |
| Viterbi | An algorithm to compute the optimal (most likely) state |
| | sequence in a hidden Markov model, given a sequence of |
| | observed outputs. |
| XML | eXtensible Markup Language. |
| | A simple SGML dialect. The goal of XML is to enable |
| | generic SGML to be served, received, and processed on |
| | the Web in the way that is now possible with HTML. |
| | While simpler than SGML, XML has a more flexible tag |
| | definition system than the format based tags used in |
| | HTML. This allows a far wider range of information to |
| | be stored and exchanged than is possible with HTML. |
| | Many CVM definitions are stored in XML file format. |
| | Refer to http://www.w3.org/XML/ |

1. A method of testing an engine designed to perform a real-time DSP or communications high resource function on an embedded target platform, the method comprising the steps of:
(a) developing a reference engine for the high resource function, the reference engine performing the same functionality as the engine but running on a desktop computer and not the target platform;
(b) conformance testing the engine against the reference engine by measuring the functionality of the engine when stimulated by stimulus vectors and comparing that functionality against the reference engine.

2. The method of claim 1 in which the reference engine is an accurate behavioural description of the high resource function.

3. The method of claim 1 in which a desktop computer allows the conformance tests to be executed in the development environment of the target platform.

4. The method of claim 3 in which the desktop computer issues a conformance certificate that is securely associated with the engine if conformance tests for all vectors are passed.

5. The method of claim 1 in which the reference engine is polymorphic in that it can handle a general data type covering a range of bit-widths and/or overflow behaviours and any engine whose specific data type is a sub-set of the general data type can therefore be conformance tested against that reference engine.

6. The method of claim 5 as performed using an engine interface, in which an engine interface that relates to the specific data type is derived from the reference engine and an engine that relates to a target platform is then derived from the engine interface.

7. The method of claim 1 in which conformance testing (i) the engine and (ii) a further engine designed to provide the same high resource function but to run on a different target platform against the reference engine validates the behavioural equivalence of the engines.

8. The method of claim 7 in which the further engine is a ported version of the engine.

9. The method of claim 7 when used to give the system designer the ability to choose from one of several different target platform/engine pairs when actually deploying a system, because he knows that whichever platform he chooses, he will have an engine that runs on that platform to perform the high resource function in a way that is behaviourally the same as any other engine (specific to a different platform) he might have chosen.

10. The method of claim 1 in which the engine has automatically generated infrastructure code that handles (i) memory management and (ii) communication with client or control code that needs to make use of the high resource function.

11. The method of claim 1 in which the engine separated from executive client code that accesses the engine by a virtual machine layer.

12. The method of claim 1 in which the engine is performance profiled by measuring the functionality of the engine in order to build up a set of points on a multi-dimensional surface that can later be interpolated to make useful estimates of engine execution time and resource usage.

13. The method of claim 12 in which the profile indicates how well the engine should perform in terms of processor cycles and memory loading given a range of input values, such as a set of input data lengths.

14. The method of claim 1 in which either the reference engine or the engine is used to create a functional block and a modelling environment is used to model the performance of the functional block.

15. A device capable of performing a real-time DSP or communications function, the device comprising an engine that has been conformance tested using the method of claim 1.

16. A computer program for use with a development environment for a target platform, the computer program enabling the method of claim 1 to be performed on a desktop computer.
